(19) United States
(12) Patent Application Publication
(10) Pub. No.: US 2007/0205085 A1
(43) Pub. Date: Sep. 6, 2007

(54) Chain For Conveying Logs Or The Like

(75) Inventors: Kevin R. McLaughlin, Alpharetta, GA (US); Ian R. Bingham, Portland, OR (US); Dean F. Richards, Hillsboro, OR (US)

Correspondence Address: PLUMSEA LAW GROUP, LLC, 10411 MOTOR CITY DRIVE, SUITE 320, BETHESDA, MD, 20817, US

(73) Assignee: ESCO Corporation, Portland, OR (US)

(21) Appl. No.: 11/681,042

(22) Filed: Mar. 1, 2007

Related U.S. Application Data
(60) Provisional application No. 60/778,958, filed on Mar. 2, 2006.

(51) Int. Cl. B65G 17/06

(52) U.S. Cl. 198/850; 198/853; 198/698

(57) ABSTRACT

A chain for conveying logs may be formed of both fabricated and cast links to produce a chain that is durable and economical. The chain includes a plurality of driving links each having at least one contact for engaging the logs and a plurality of common links free of the contacts. Whereas each of the driving links are formed as a cast link, each of the common links is formed as a fabricated link.

### CROSS-REFERENCE TO RELATED APPLICATION

This non-provisional U.S. Patent Application claims priority under 35 U.S.C. §119(e)(1) to provisional U.S. Patent Application Ser. No. 60/778,958, which was filed in the U.S. Patent and Trademark Office on Mar. 2, 2006 and entitled Chain For Conveying Logs Or The Like, such prior provisional U.S. Patent Application being entirely incorporated herein by reference.

### FIELD OF THE INVENTION

The present invention pertains to a chain for use in conveying logs or the like in, for example, lumber and paper mills.

### BACKGROUND OF THE INVENTION

Chains are commonly used in machines to convey logs in lumber and paper mills. These chains are typically made of fabricated links where individual side and cross pieces of each link are welded together. Fabricated links have been made with many different constructions. In one example, the side pieces are bars with an offset portion so that the side pieces at one end are closer together than at the opposite end. The narrower end then fits within the wider end of an adjacent link. The narrower end is joined together by a tubular cross piece that receives a pin extending through the side pieces of the two adjacent links. The pin includes a head on one end and an opposite free end that is deformed as a rivet or other means of retention to retain the links together.

Irrespective of the shape of the links, selected links are provided with contacts for engaging and pushing the logs forward. In one example, upright flanges are welded to the side bars of the selected links in the chain so as to extend above the remainder of the chain. The distal ends of the contacts dig into the logs so as to haul the logs along the course prescribed by the chain. The links with contacts will typically be spaced apart by, for example, five to fifteen other links.

The conveying of logs applies high loads and levels of stress to the conveying chains. Despite being formed of hardened steel, the chains in many cases still wear out or break down at frequent intervals on account of the harsh environment. In an effort to provide more durable chains, chains composed of cast links have been made. Each cast link is cast as a one-piece member of hardened steel with unitary side and cross pieces. In general, the cast links can also have wide variations in shape. While the cast link chains are more durable than fabricated link chains, their high cost of manufacture has limited their acceptance in the market.

### SUMMARY OF THE INVENTION

The present invention pertains to an improved chain for conveying logs formed of both fabricated and cast links to produce a chain that is durable and economical.

In one aspect of the invention, the chain is formed substantially of fabricated links. The links formed with contacts for engaging the logs, however, are formed as cast links. Since the links with contacts carry more load and experience more abuse than the remaining links, the use of cast links for the links with contacts produces a chain with an extended useful life. Nevertheless, since the links with contacts typically comprise only a small portion of the total links in the chain, the cost of manufacture is only incrementally more than a conventional fabricated chain.

In another aspect of the invention, the chain includes a plurality of driving links each including a contact for engaging the logs and a plurality of common links that are free of such contacts. Each of the driving links are cast as one-piece links, whereas each of the common links are formed as fabricated or welded links.

The advantages and features of novelty characterizing aspects of the invention are pointed out with particularity in the appended claims. To gain an improved understanding of the advantages and features of novelty, however, reference may be made to the following descriptive matter and accompanying drawings that describe and illustrate various embodiments and concepts related to the invention.

### DESCRIPTION OF THE DRAWINGS

FIGS. 1 and 2 are each a perspective view of a length of chain in accordance with the present invention.

FIG. 3 is a top view of the length of chain.

FIG. 4 is a perspective view of two fabricated links of the length of chain.

FIG. 5 is a top view of the two fabricated links of FIG. 4.

FIG. 6 is a perspective view of a single cast driving link of the length of chain.

FIG. 7 is a top view of the cast driving link.

### DETAILED DESCRIPTION OF THE INVENTION

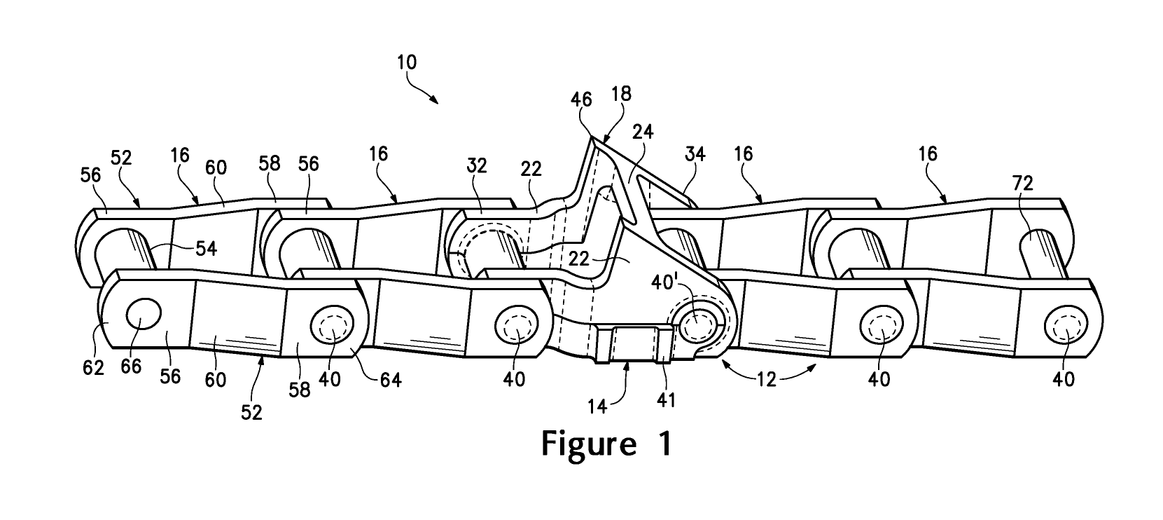

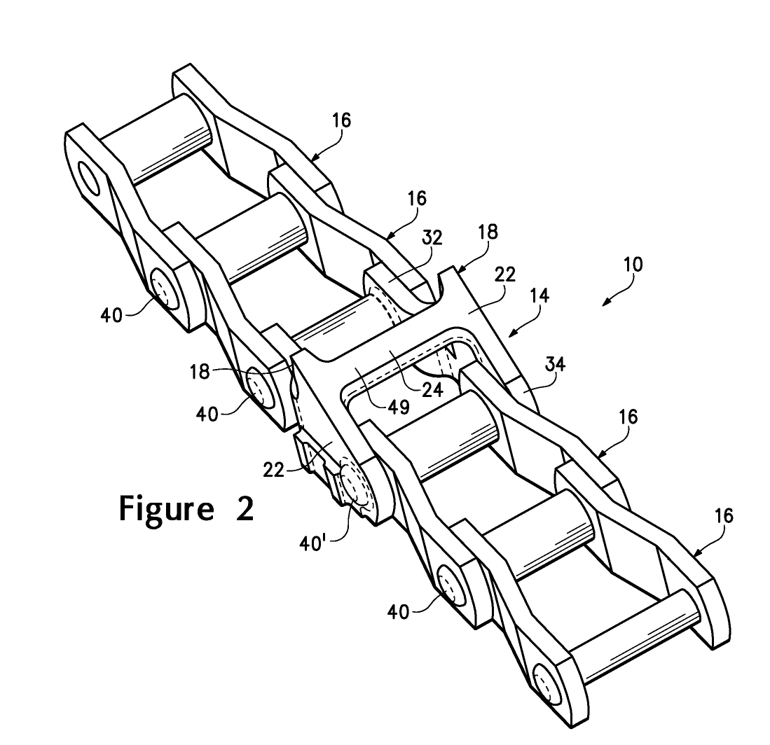

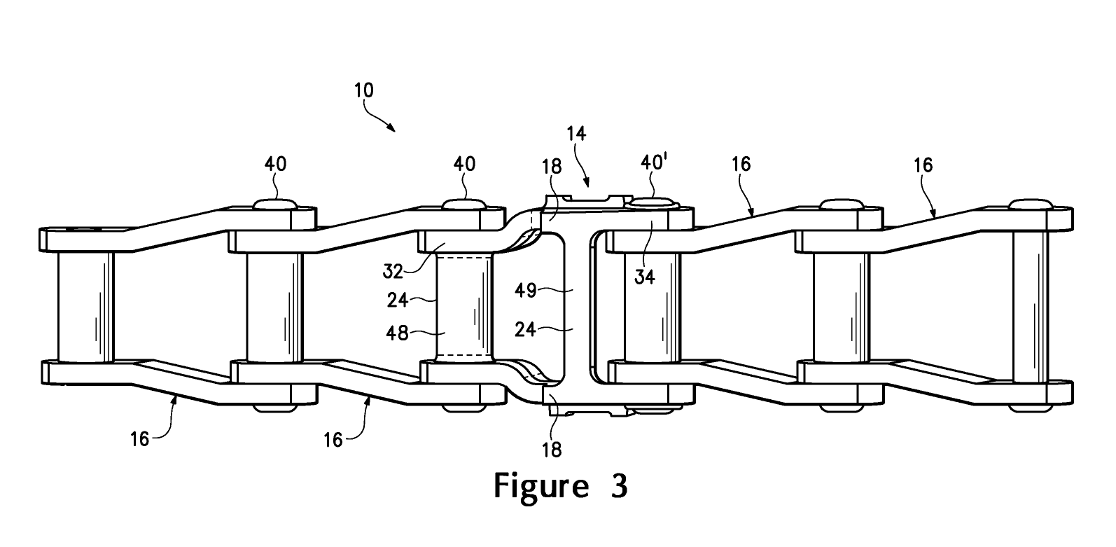

The present invention pertains to a chain 10 for use in a conveyor (not shown) for moving logs in, for example, a lumber or paper mill. The chain is composed of an endless series of connected links 12 so as to form a loop. A sample length of the chain in accordance with the present invention is shown in FIGS. 1-3. While the links are shown in the drawings with a particular shape for descriptive purposes, the invention is not limited to a particular shape of link.

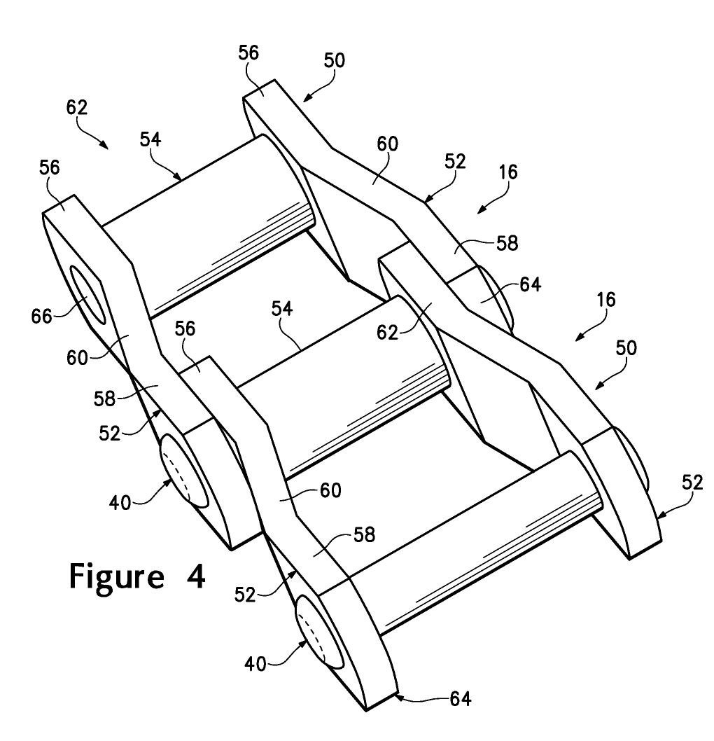

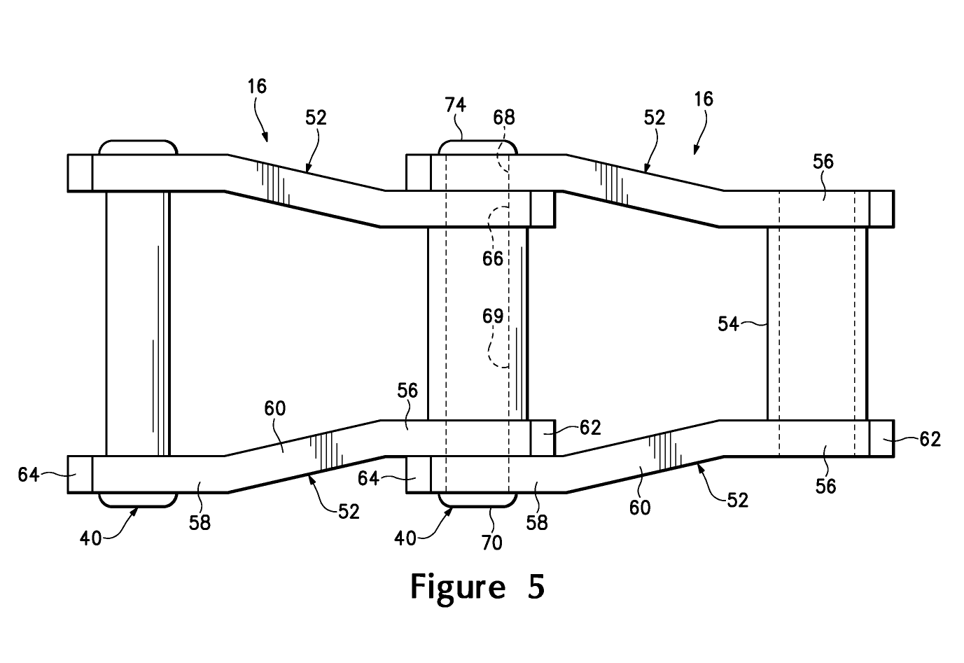

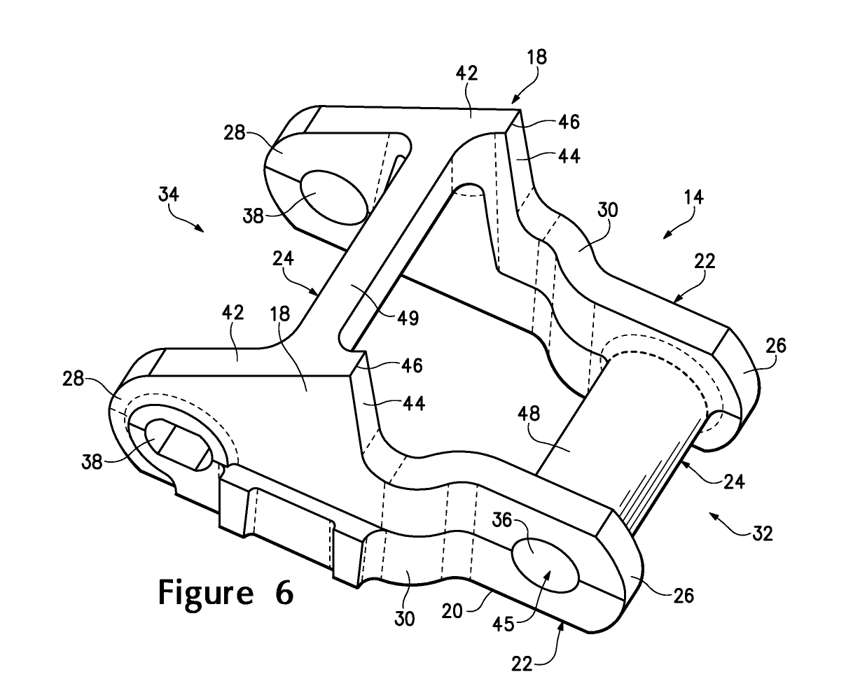

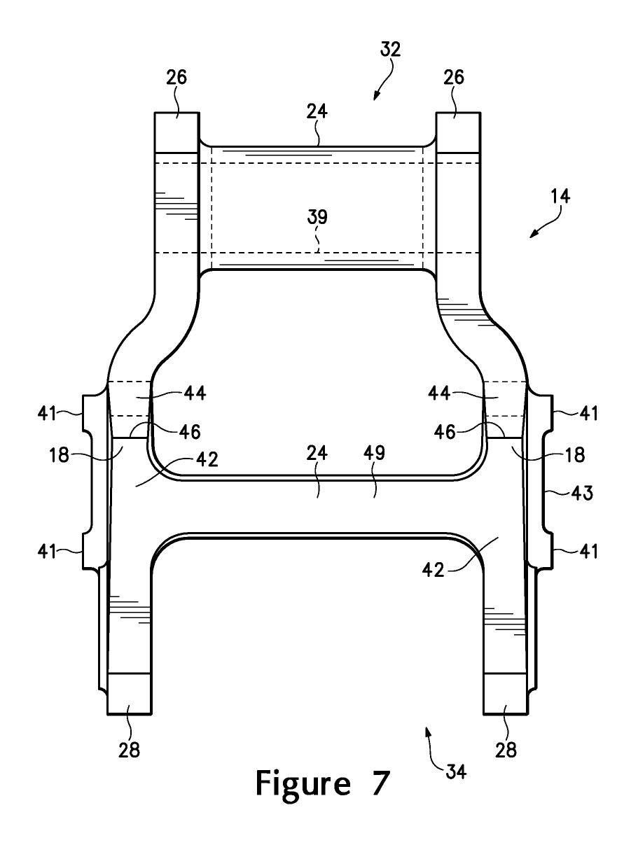

Chain 10 comprises driving links 14 and common links 16. Driving links 14 are provided with contacts 18 which project from the link to engage and move the log along the course of the chain (FIGS. 1-3 and 6-7). Common links 16 are the remaining links that are free of contacts and thus do not directly engage the logs (FIGS. 1-5). Preferably, a plurality of common links is provided between each pair of adjacent driving links. As an example only, five to fifteen common links may be present between each pair of driving links, but other numbers of common links can be used as well. It is also possible to couple two or more driving links 14 in a series without separation by common links 16 or to provide a single common link 16 between each driving link 14.

In accordance with the present invention, chain 10 is preferably formed substantially of fabricated links (sometimes called welded links) and a selected number of cast links. The driving links are formed as cast links while the common links are preferably formed as fabricated links. Each fabricated link is made by welding multiple pieces together into a single link. Each cast link is cast as a one-piece member. Since driving links 14 carry more load and experience more abuse than common links 16, the use of cast links for the driving links produces a chain with an extended useful life. In addition, since the driving links may comprise only a small portion of the total links in the chain, the cost of manufacture can be only incrementally more than a conventional fabricated chain. Also, by forming the driving links as cast links, they can be composed of a harder and stronger steel than would normally be suitable to accommodate the welding needed to make a fabricated link. Hence, the life of the cast links and, in turn, the chain can be extended even longer with the use of such materials.

Each driving link 14 is cast as a one-piece member 20 having side pieces 22 and one or more cross pieces 24 (FIGS. 1-3 and 6-7). In one preferred example, side pieces 22 are mirror images of each other. Each side piece 22 includes a first end 26, a second end 28, and a medial offset portion 30. Offset portion 30 has a broad S-shape so that first ends 26 of each link are closer to each other to form a narrow end 32 of the link as compared to the second ends 28 which form a wide end 34 of the link. In forming the chain, narrow end 32 fits within wide end 34 of an adjacent link. Each end 26, 28 defines a hole 36, 38 for receiving a pin 40 for connecting adjacent links into a chain. Each side piece 22 further includes a pair of spaced wear members 41 that protect the links against premature wear along the track (not shown) in which the chain ordinarily runs. The space 43 between wear members 41 on each side pieces 22 is a preferred location for a riser connection in casting the links. In some configurations, links without contacts 18 may be cast as a one-piece member.

Each side piece 22 further includes a contact 18 preferably positioned along second end 28 adjacent offset portion 30. In this example, contact 18 is defined as a raised portion of side piece 22 with a gradually increasing ramp surface 42 and a steep step surface 44. Ramp surface 42 and step surface 44 intersect to form an engaging corner 46 to engage and drive logs forward with the chain. Nonetheless, a myriad of other kinds of contacts could be used to form the driving links.

A first cross piece 48 extends between first ends 26 of side pieces 22, preferably as a tubular member with a central passage 39 that aligns with holes 36 to define a through-hole 45 in the link. A second cross piece 49 extends between second ends 28 near engaging corners 46 as a straight bar. Second cross piece 49 is preferably axially offset from first cross piece 48 and holes 36, 38, and located near engaging corners 46, in order to strengthen contacts 18 and resist spreading or other deformation during use. The positioning of second cross piece 49 also provides ample clearance for receiving the narrow end and the cross piece from an adjacent link. In some configurations, second cross piece 49 may be absent from each driving link 14.

Common links 16 are formed as fabricated links 50 (FIGS. 1-5). In one preferred embodiment, each fabricated link 50 includes two side pieces 52 and a single cross piece 54. The two side pieces 52 in each link 50 are identical but reversed and assembled to be mirror images of each other. Each side piece 52 includes a first end 56, a second end 58 and a medial offset portion 60. The first and second ends 56, 58 are generally parallel to each other but offset by the angled offset portion 60. As with cast links 20, the first ends 54 of fabricated links 50 are closer together than second ends 56 to form a narrow end 62 and a wide end 64. The wide end 64 is adapted to receive a narrow end 32, 62 of an adjacent link 14 or 16. Each end 54, 56 of each side piece 52 includes a hole 66, 68 for receiving pin 40. In some configurations, common links 16 may be cast as a one-piece member.

Cross piece 54 is preferably a tubular member that extends between first ends 56 of side pieces 52. The tubular member includes a central passage 69 that aligns with first holes 66. The second ends 58 of side pieces 52 are interconnected only by a pin 40 received through second holes 68 and the narrow end 32, 62 of the adjacent link 14 or 16. In a fabricated link, each side piece 52 is welded to cross piece 54. While a fabricated link is less durable than a cast link, it is more economical to make.

Pins 40 coupling links 14, 16 together are similar. Each pin 40 includes a head 70 on one end that is larger than holes 36, 38, 56, 58, and a shank 72. Shank 72 passes through holes 36, 38, 56, 58 and cross pieces 24, 54 to connect the links together. The free end 74 of shank 72 is deformed as a rivet to prevent removal of pin 40 once assembled into a pair of adjacent links 14, 16. Nonetheless, other pin constructions could be used.

In the preferred construction, pins 40 are fixed relative to wide end 34, 54 of links 14, 16, and rotates relative to narrow ends 32, 52 i.e., within passages 39, 69 of cross pieces 24, 54. In regard to fabricated links 50, holes 68 are stamped (or otherwise formed) to have an interference fit with shank 72 of pin 40. In regard to cast links 20, holes 38 in the wide end 34 are not the same in each of the side pieces 22, but they could be if desired. Rather, hole 38a is preferably elongated along the axis of one side piece 22 so as to have an oval or racetrack shape to prevent pin rotation; i.e., the shank of pin 40′ includes flats (not shown) that correspond to the flats in hole 38a. The remaining holes 36, 38b are preferably circular.

The invention is disclosed above and in the accompanying drawings with reference to a variety of embodiments. The purpose served by the disclosure, however, is to provide an example of the various features and concepts related to the invention, not to limit the scope of the invention. One skilled in the relevant art will recognize that numerous variations and modifications may be made to the embodiments described above without departing from the scope of the present invention, as defined by the appended claims.

1. A chain for conveying logs or the like, the chain comprising:
a first link with a one-piece configuration;
a second link formed from at least two pieces joined with a weld; and
a pin that rotatably-secures the first link to the second link.

2. The chain recited in claim 1, wherein the first link includes a contact that extends outward from the first link for engaging the logs.

3. The chain recited in claim 1, wherein each of the first link and the second link includes a pair of side pieces and a cross piece extending between the side pieces.

4. The chain recited in claim 3, wherein at least one contact for engaging the logs extends outward from the side pieces of the first link, and the second link is free of a contact for engaging the logs.

5. The chain recited in claim 1, wherein the first link is formed of a first material and the second link is formed of a second material having a lesser hardness than the first material.

6. The chain recited in claim 5, wherein the first material and the second material are steel.

7. The chain recited in claim 1, wherein the chain includes a plurality of links, a majority of the links having a configuration of the second link.

8. A chain for conveying logs or the like, the chain comprising:
driving links that each includes a contact for engaging the logs, each of the driving links having a one-piece configuration;
common links free of contacts for engaging the logs and including at least two elements welded together; and
a plurality of pins that join the links to each other.

9. The chain recited in claim 8, wherein the chain includes more of the common links than the driving links.

10. The chain recited in claim 8, wherein the chain is predominantly formed from the common links.

11. The chain recited in claim 8, wherein a series of least five of the common links extend between each adjacent pair of the driving links.

12. The chain recited in claim 8, wherein each of the driving links and common links includes a pair of side pieces and a cross piece extending between the side pieces.

13. The chain recited in claim 12, wherein the contacts of the driving links extend outward from the side pieces.

14. The chain recited in claim 8, wherein the driving links are formed from a first steel material and the common links are formed from a second steel material, the first steel material having a greater hardness than the second steel material.

15. The chain recited in claim 8, further including at least one common link free of contacts for engaging the logs and having the one-piece configuration.

16. A method of manufacturing a chain for conveying logs or the like, the method including steps of:
casting a plurality of first links, each of the first links having a one-piece configuration;
fabricating a plurality of second links, each of the second links being formed by welding at least two elements together; and
joining the links to each other.

17. The method recited in claim 16, wherein the step of casting includes forming contacts that project outward from each of the first links to engage the logs.

18. The method recited in claim 17, wherein the step of fabricating includes forming the second links to be free of contacts for engaging the logs.

19. The method recited in claim 16, wherein the step of casting includes forming contacts that project outward from at least a portion of the first links to engage the logs.

20. The method recited in claim 16, wherein the step of joining includes utilizing a greater number of the second links than the first links.

21. The method recited in claim 16, wherein the step of joining includes securing a series of at least five of the second links together between two of the first links.

22. The method recited in claim 16, wherein the first link is cast of a first steel material and the second link is composed of a second steel material less hard than the first steel material.

23. The method recited in claim 16, wherein the steps of casting and fabricating include forming each of the first links and the second links to have a pair of side pieces and a cross piece extending between the side pieces.

24. A method of using a chain to convey logs or the like, the method comprising:
providing an endless chain having a plurality of one-piece driving links with contacts and a plurality of common links free of contacts, at least some of the common links being formed of a plurality of pieces welded together;
engaging logs with the contacts from the driving links; and
moving the chain along a prescribed course to convey the logs from a first position to a second position.

25. The method recited in claim 24, wherein the provided endless chain includes a greater number of the common links formed of a plurality of welded pieces than the driving links.
